(19) United States
(12) Patent Application Publication
(10) Pub. No.: US 2005/0081927 A1
(43) Pub. Date: Apr. 21, 2005

(54) Flushing system

(76) Inventor: R. Glenn Akhavein, Bradenton, FL (US)

Correspondence Address: R. Glenn Akhavein, 5112 Coral Blvd., Bradenton, FL, 34210, US

(21) Appl. No.: 10/689,104

(22) Filed: Oct. 20, 2003

(51) Int. Cl. G05D 7/00

(52) U.S. Cl. 137/599.14

(57) ABSTRACT

This invention relates to a novel, yet simple system and process for flushing marine propulsion systems with a desired fluid. This flushing system for marine propulsion systems is inserted into the flow path normally used for conducting raw water to the engine or heat exchanger for cooling purposes. A first attachment means allows cooling fluid to flow into the system and a second attachment means allows for cooling fluid to flow out of the system. The flushing system allows the vessel to be flushed with or without the engine running and with the vessel in or out of the water.

### BACKGROUND OF THE INVENTION

1. Field of the Invention

This invention relates to a novel, yet simple system and process for flushing marine propulsion systems with a desired fluid. This flushing system and process allows a person to quickly and easily flush an engine or heat exchanger whether the boat is in the water or out of the water with or without the engine running.

The need for such a system is commonly seen with marine engines. When a marine engine is operated, in fresh water or salt water, impurities in the water can cause cooling problems and corrosion of components if not properly flushed. Debris of various types can be picked up in lakes and rivers, and even the cleanest ocean water is going to have salt in it. Therefore, it is imperative that marine engines get flushed after every use.

The difficulty is that flushing marine engines can be very cumbersome since the intake for cooling fluids is in the hull beneath the waterline or in the outdrive near the propeller. In either case, the intake points for flushing the engine are difficult to reach, and the intakes remain underwater unless the boat is physically removed from the water.

The invention eliminates the difficulty of the flushing process. This system has no valves to clog or components to corrode, is accessed from the topside of the boat, is simple to use, is inexpensive, and is easily installed by one that is not versed in the art. The novelty of this invention is in its versatility and its simplicity.

2. Prior Art

There are a number of approaches to flushing marine drives. Some are designed to flush outboard drives, some inboard drives, some inboard/outboard drives, some diesel or hybrid drives, and some a combination of drives. Those that are known that will work for inboard, inboard/outboard, and/or diesel hybrid drives, such as the present invention, are: U.S. Pat. No. 3,550,612 issued Dec. 29, 1970 to Maxon discloses a purge valve for cooling fluid conduit system; U.S. Pat. No. 4,619,618 issued Oct. 28, 1986 to Patti discloses a fresh water flushing kit; U.S. Pat. No. 5,251,670 issued Oct. 12, 1993 to Bates discloses a flush valve; and U.S. Pat. No. 5,295,880 issued Mar. 22, 1994 to Parker discloses a flushing valve for inboard boat engines.

For the most part, the devices prior to this one involve elongated conduits with multiple valves, manually operated valves, check valves, or have complicated directional control valve mechanisms. Such devices inherently require proper performance of sequential steps that must be completed and then reversed at the end of the flushing process, or rely on check valves, directional control valves, or other devices that are supposed to perform in a specific manner while flushing the engine and then perform in another manner when not in an engine flushing process.

The combination of complicated operational procedures, fluid flow design and flow design components, and the physical locations of such prior art devices often presents the risk that an improper operational procedure or an unknown malfunction of a fluid flow component will expose the vessel to taking on seawater, not functioning correctly under normal operation which can result in ruining a marine engine and/or outdrive components, or at the very least, not properly completing the task for which they are designed, that is, thoroughly flushing a marine engine.

In Maxon and in Parker, a device is situated in the coolant flow path and proper operation of the system is dependent upon either a ball or similar component being displaced by the incoming cooling fluid. Then these components are displaced in the opposite direction during the flushing cycle. While these devices avoid the need for manual intervention, the constant exposure to corrosive environments, abrasive contaminants such as sand and mud, and larger floating debris, can lead to component failure, valve seat failure, as well as failure due to large debris being trapped within the device. This all leads to an inherently unreliable fluid control system over the life of the vessel.

The other significant limitation to both of these devices is that they cannot be used with an inboard/outboard marine engine that has the seawater pump in the outdrive. Any device that is to be used on an inboard/outboard marine engine that has a pump in the outdrive must contain a method for dealing with the fluid that is being pumped from the outdrive. If fluid from the outdrive is not allowed to continue to flow, the pressure on the outlet of the outdrive pump will increase and the pump will fail.

In Patti and in Bates, a device is also situated in the coolant flow path, and these devices are designed to work with both inboard and inboard/outboard marine engines. However, both of these devices rely upon complicated assemblies and components. As with the previously mentioned devices, the constant exposure to corrosive environments, abrasive contaminants such as sand and mud, and larger floating debris, can lead to component failure, valve seat failure, as well as failure due to large debris being trapped within the devices. This all leads to an inherently unreliable fluid control system over the life of the vessel.

Patti's device consists of a long tubular assembly having a shutoff valve between a seawater inlet and outlet, a second shutoff valve between a freshwater inlet and outlet, and a complicated process for changing from normal operation to flushing and then back again to normal operation. Bates' device does not have similar complexity in the process of changing from normal operation to flushing and back. However, the device itself is dramatically more complicated, which makes it more susceptible to the failures mentioned above, and it is a much more expensive design due to the number of sliding seals and the inherent difficulty maintaining this style of seal in the presence of so many abrasive contaminants.

This leads to another problem for both Patti's and Bates' devices; the potential to have port-to-port leakage during the flushing process that cannot be easily determined, if at all. During the flushing process with an inboard/outboard marine engine both the freshwater line and the seawater pump line are pressurized. Over time, if there is wear on the seals, valve seats, or in Bates' case, the body material between the two seals, there can be port-to-port leakage. This has the potential of introducing contaminants and saltwater into the engine during the flushing cycle. Since this is not easily determined, if at all, the signs of this happening will not be apparent until there is substantial damage to the engine, exhaust manifold, or risers, all of which are very expensive to replace.

As previously mentioned, both Patti's and Bates' devices can be used with an inboard or an inboard/outboard marine engine; however, neither of these devices can be used to flush a marine engine with an outdrive pump while the engine is running and the boat is out of the water. It is very important to run a marine engine during the flushing process so that the thermostat remains open. If the engine is off, the cold flushing fluid will immediately cause the thermostat to close, which will in turn close off much of the engine to the flushing fluid thereby dramatically shortening the life of the marine engine.

Boat owners that keep their boats on lifts or davits generally prefer to remove the vessel before beginning a thorough wash down. This allows for a person to rinse the vessel's hull and outdrive while flushing the engine. Also, many commercial establishments, especially ones that are very busy, will remove vessels from the water and complete the exterior wash down and engine flushing service at another location within the establishment.

### SUMMARY OF INVENTION

The main object of the current invention is to provide a simple, inexpensive, and reliable method for thoroughly flushing marine propulsion systems. The current invention is primarily used on a marine inboard engine or inboard/outboard engine with a seawater pump in the engine compartment, or an inboard/outboard engine with a seawater pump in the outdrive. The invention can be used with or without the engine running and with the vessel either in or out of the water. The current invention is also applicable with diesel, diesel hybrid, and diesel genset engines, as well as marine heat exchangers used on closed cooling systems. The novelty of this invention is in its versatility and its simplicity.

The system can be situated anywhere on the vessel, but in the preferred embodiment it is located above deck in a location similar to where the gasoline, water, or waste ports are located, or in the cockpit. For engines with the seawater pump in the outdrive the system is spliced in between the outlet of the outdrive seawater pump and the inlet of the engine pump. For engines with the seawater pump in the engine compartment or with heat exchangers, for engines with a closed cooling system, the device may be spliced in before or after the seawater pump. It should be noted that when reference is made to engines with a seawater pump in the engine compartment, this also includes heat exchangers with closed cooling systems. During normal operation of the vessel, seawater simply passes through the system, and since the system is scalable, it can easily be adapted to any size engine. There are no valves to clog or corrode.

When the vessel is ready for the flushing cycle, there are two different methods to flush the marine engine depending upon whether the vessel is in or out of the water. In either case, the engine is momentarily turned off, the outlet cap is removed from the system to allow a hose to be attached to provide freshwater to the engine pump. The hose could be attached directly to the system; however, in the preferred embodiment, the cap has an inner plug that is threaded to accommodate a hose. The cap is removed, and then the inner threaded plug is removed. This allows the cap to be easily screwed on to the end of the hose. The cap and attached hose are then inserted back into the system, and rotated to either the FLUSH IN WATER position or the FLUSH OUT OF WATER position depending on whether the vessel is in or out of the water.

When the vessel is in the water, the freshwater hose is attached as previously described, rotated to the FLUSH IN WATER position, the inlet cap is removed, and the engine is started. Fresh water is supplied to the engine from the hose, and water from the seawater pump is allowed to flow out of the vessel. In the preferred embodiment, there is an inner hose that is seated under the inlet cap that can be pulled out so that the water from the seawater pump is directed over the side of the vessel or into a drain.

When the flushing cycle is completed, the engine is turned off, the inner hose is slid back into place, the freshwater hose is removed from the outlet cap, the outlet cap plug is threaded back into place, and both caps are replaced and rotated to the RUN position. The system can be changed from the normal position to the flushing cycle position and back in well under one minute. Then it is simply up to the individual to decide how long to run the engine to sufficiently flush out the contaminants and saltwater that was in the engine. Having saltwater in the outdrive portion of the vessel is not harmful to the outdrive components as long as the vessel remains in the water.

If the vessel is going to be pulled out of the water, the flushing cycle is even simpler. The freshwater hose is attached as previously described. Then the inlet cap and the outlet cap are simply rotated to the FLUSH OUT OF WATER position, and the vessel is ready for flushing.

During the flushing cycle a small portion of the flushing fluid is diverted from going to the engine and is sent to the seawater pump to flush it and keep it from overheating. Previous systems have no method for providing a seawater pump with fluid while the engine is running and the vessel is out of the water. Without this diverted fluid, the seawater pump would run dry and be damaged within the first thirty seconds of the flushing cycle. After the flushing cycle, the hose is removed from the outlet cap, the plug and the outlet cap are replaced into the system, and both caps are rotated back to the RUN position.

Another object of this invention is to make the flushing process simple and as close to foolproof as possible. The system is designed and marked in a manner that makes switching from the normal operating position to the flushing position and back, almost intuitive. The system is designed so that the inlet cap and the outlet cap have clearly marked positions for normal operation, flushing the engine while in the water, and flushing the engine while out of the water. The caps are also designed so that they cannot be locked into a position where the engine may be damaged. Also, the system is designed so that the vessel will function properly even if the operator forgets to return the system to the normal run position after flushing the engine.

A further object of this invention is to create a system that is very simple to install. A person not skilled in the art of marine installation can easily install this system. A knife, a screwdriver, and a drill are all that is needed.

Another object of this invention is to provide the vessel operator with a method of monitoring the quantity and/or quality of the engine cooling water during normal operation. The current invention does this in a number of ways. Either the inlet cap or the outlet cap could be made from a clear material so that the fluid going through the system can be seen. As previously mentioned, in the preferred embodiment, the outlet cap has an inner threaded plug that is removed to allow for the attachment of a freshwater hose for flushing. This plug can be produced from a clear material. This provides a close up view of the fluid passing from the seawater pump pickup to the engine.

When boating in shallow water, having someone monitor the fluid going to the engine can give a good indication as to how much sand or silt the seawater pump is picking up. This can help reduce wear on the engine. Monitoring the fluid can also be used as a shallow water depth gauge. As the vessel's hull or outdrive approaches the bottom, a drop in depth of just a few inches can dramatically increase the amount of sand and silt that the seawater pump picks up. Those few inches can mean the difference between floating and being grounded, thereby avoiding towing costs as well as the additional costs of running the vessels hull and/or outdrive through the sand.

Also, the inlet cap can have a monitoring device mounted in it that reflects some aspect of the fluid traveling through the system. If the system is to be mounted in a part of the boat that is not easily seen, a remote gauge can be attached to the system. In the preferred embodiment, the system has either a built in monitoring device or a feature that can be used to attach a conduit that could have a monitoring device mounted on the end of it that was placed in sight of the vessel's operator.

A further object of this invention is its use as an emergency system. Even though this system is not intended to be used as an emergency system, it can be if it is believed that there could be a loss of life and/or a loss of the vessel. If the vessel is taking on water, and the existing bailing means are not adequate or not functioning but the engine is still running, the system can be used as an emergency pump.

In an emergency situation, when it is believed that the vessel will sink due to the amount of water coming onboard, the outlet hose from this system can be disconnected and placed at a low point, usually well below the engine. This now becomes the inlet for the engine pump. As the engine runs it becomes a high volume bilge pump. Once the engine begins to pump water from within the vessel, the inlet cap is removed from the system, in the manner mentioned earlier, and the inner hose is extended so that the fluid from the seawater pump is sent over the side of the vessel.

Once the vessel is no longer in an emergency situation, the system's inner hose and inlet cap can be replaced, and the outlet hose can be reconnected.

Other aspects of this invention are disclosed infra.

### BRIEF DESCRIPTION OF THE DRAWINGS

FIG. 1 is a view of the general positioning of the flushing system relative to the vessel's engine and pumps. It also shows some of the possible places where it can be installed depending upon whether the vessel has an inboard engine, inboard/outboard engine with a seawater pump in the engine compartment, or an inboard/outboard engine with a seawater pump in the outdrive.

FIG. 2 is an exterior view of the top of the preferred embodiment of the current invention showing the system in the standard engine running position.

FIG. 3 is a partial section of the preferred embodiment of the flushing system described in the current invention. It shows with arrows the cooling water coming in and passing through the flushing system in the standard engine running position.

FIG. 4A-6B are comparison views showing an exterior isometric view and its accompanying cross sectional view of the preferred embodiment of the current invention in its three primary positions; FIG. 4A-B, standard running the engine, FIG. 5A-B, flushing the engine with the vessel out of the water, and FIGS 6A-B, flushing the engine with the vessel in the water.

FIG. 4A is an exterior view of the flushing system in the standard running the engine position. This is the position the flushing system is left in at all times other than when flushing the engine.

FIG. 4B is a cross sectional view of FIG. 4A showing with arrows the direction that the coolant fluid travels in the standard engine running position.

FIG. 5A is an exterior view of the flushing system while flushing the engine with the vessel out of the water. It shows the attachment of a hose to deliver clean flushing fluids, and the position of the major components during the flushing out of the water cycle.

FIG. 5B is a cross sectional view of FIG. 5A showing the direction that the coolant fluid travels while flushing the engine with the vessel out of the water. It also shows a cross sectional view of the position of some of the components during the cycle. The arrows illustrate the flow of flushing fluids into the system and the flow, out of the system, of flushing fluids to the engine pump and to the seawater pump.

FIG. 6A is an exterior view of the flushing system while flushing the engine with the vessel in the water. It shows the attachment of a hose to deliver clean flushing fluids, and the position of the major components during the flushing in the water cycle, and the position of the interior hose that diverts water from the seawater pump out of the system.

FIG. 6B is a cross sectional view of FIG. 6A showing the direction that the coolant fluid travels while flushing the engine with the vessel in the water. It also shows a cross sectional view of the position of some of the components during the cycle. The arrows illustrate, on the left, the flow of flushing fluids into the system and out of the system to the engine pump. The arrows also illustrate, on the right, the flow of fluid from the seawater pump into the system through the inner hose, and then overboard.

The same reference numerals refer to the same parts throughout the various Figures.

### DETAILED DESCRIPTION OF THE PREFERRED EMBODIMENT

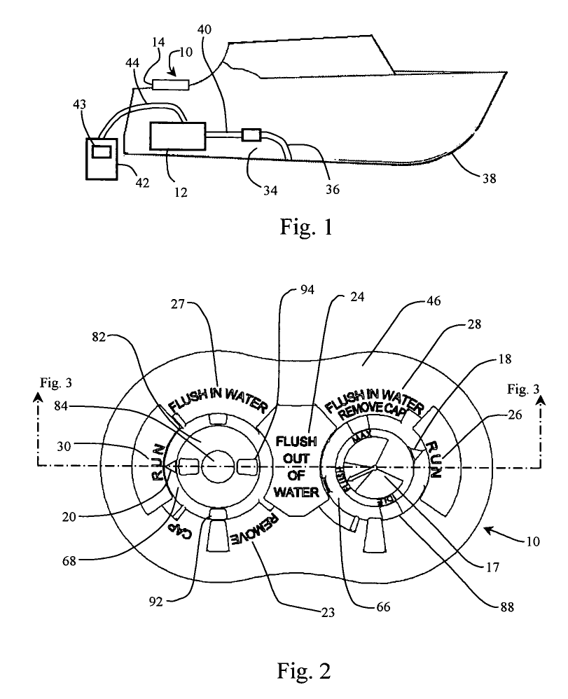

FIG. 1 shows one possible mounting location for the flushing system 10 relative to the vessel's engine 12. The flushing system 10 is generally installed in the gunwale, in the cockpit, or the top of the transom. If the flushing system 10 is installed along the side of the vessel, in the gunwale or cockpit, the inlet indicator 14 points towards the back of the vessel. If the flushing system 10 is installed in the top of the transom, the inlet indicator 14 points towards the center of the vessel. This aids in making the flushing system 10 more intuitive. There are pointers FIG. 2: 18, and 20, and verbal descriptions, 23, 24, 26, 27, 28 and 30, built into the body 46 that also aid in making the flushing system 10 easy to use. The specific uses for each will be discussed in detail.

The insertion point for the flushing system 10 varies depending upon the type of vessel. For a vessel with a seawater pump 34 in the engine compartment, the flushing system 10 can be spliced into the conduit 36 between the hull 38 and the seawater pump 34, conduit 40 between the seawater pump 34 and the engine 12, or conduit 44 between the outdrive 42 and the engine 12 depending upon where the cooling water enters the vessel. If the vessel has an engine 12 with a seawater pump 43 in the outdrive 42, the insertion point is in the conduit 44 between the outdrive 42 and the engine 12.

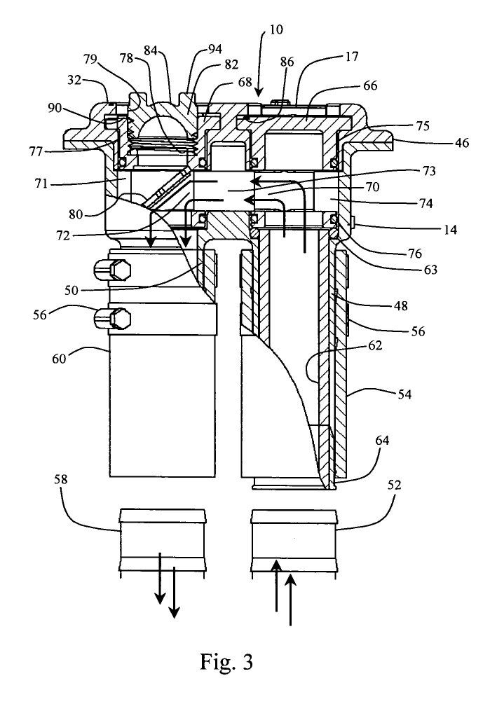

FIGS. 2 and 3 illustrate atop view of the flushing system 10 and a partial front section in the standard engine running position. The flushing system 10 is comprised of a hollow body 46 that has an inlet conduit 48 and an outlet conduit 50 that serve as attachment points. The inlet conduit 48 is connected to the incoming cooling fluid conduit or first attachment means 52 by an extension conduit or first extension means 54 that uses a connecting means 56 to secure one to the other. The outlet conduit 50 is connected to the outgoing fluid conduit or second attachment means 58 by an extension conduit or second extension means 60 that uses a connecting means 56. Inside of the inlet conduit 48 is an inner conduit 62 with sealing means 63 and 64. Any fluid flowing through the inlet conduit 48 must do so through the inside of the inner conduit 62 and the inner conduit sealing means 63 and 64.

During normal operation, cooling fluid is brought into the vessel and sent to the engine. The position indicator 18 on the inlet cap 66 points towards the RUN indicator 26, and the position indicator 20 on the outlet cap 68 points towards the RUN indicator 30. This allows the cooling fluid that enters into the body through the inner conduit 62 to pass through the inlet cap opening 70 in the inlet cap 66 and then through the outlet cap opening 72 in the outlet cap 68 and on to the engine 12 via the outlet conduit 50. Any fluid entering the inlet cap 66 and passing through the inlet cap opening 74, will pass along the outside of the inlet cap 66 and be contained by the cap seals 76 until merging with the rest of the fluid passing through the main inlet cap 13 opening 70. The inner conduit sealing means 63 and 64, the outlet cap plug sealing means 78, and a plurality of cap seals 76 contain all of the fluid entering the flushing system 10.

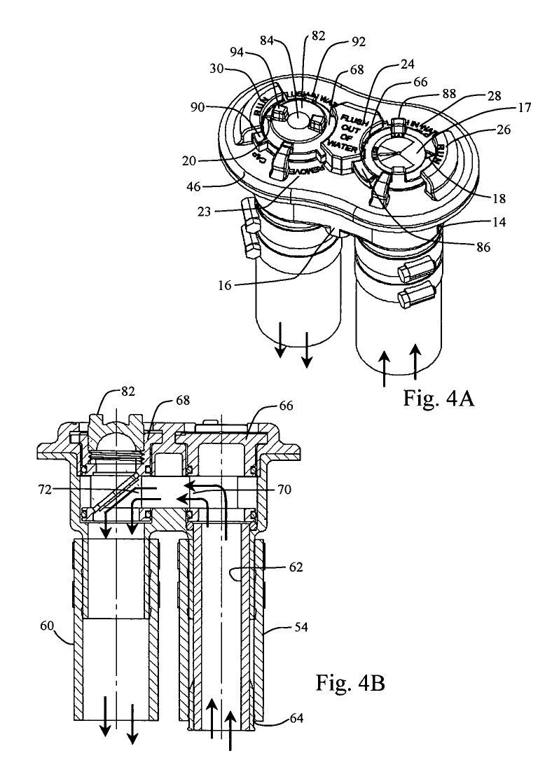

A common chamber 73 lies disposed between the inlet conduit 48 and outlet conduit 50 of the body 46. The body 46 has a plurality of sections that allow for fluid directing, metering, or regulating means to be inserted, repositioned, retained, or removed for directing, metering, or regulating the flow and/or pressure of fluid into and out of the flushing system 10. The body 46 is capable of having an extendable inner conduit 62 that can direct fluid to the common chamber 73 or direct fluid out of the common chamber 73 and body 46. The body is also capable of having a remote measuring means 16, FIG. 4A. This is a feature that allows for a remote access to the fluid going through flushing system 10. The remote measuring means 16 could be used for connecting a remote sensor so that the vessel's operator can monitor one or more of the properties of the fluid going through the flushing system 10.

The body 46 has an inlet opening 75 and an outlet opening 77. The inlet opening 75 allows for a fluid directing, metering, or regulating means to be inserted, repositioned, retained, or removed for directing, metering, or regulating the flow and/or pressure of fluid into and out of the flushing system 10. This fluid directing, metering, or regulating means is capable of having a direct measuring means 17 built into it. The outlet opening 77 allows for a fluid directing, metering, or regulating means to be inserted, repositioned, retained, or removed for directing, metering, or regulating the flow and/or pressure of fluid into and out of the flushing system 10.

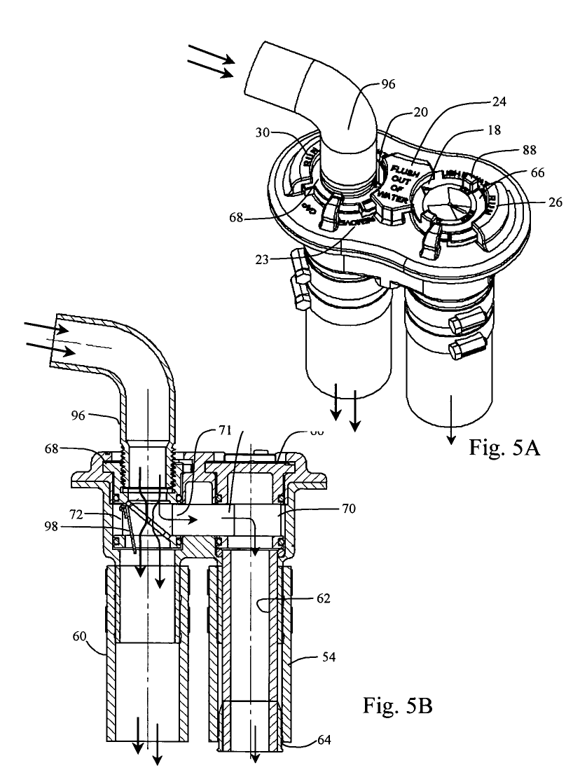

An opening 79 allows for the insertion, retention, and removal of a conduit 96, FIG. 5A, which is used to bring flushing fluid into the flushing system 10. The opening is designed so that said directing, metering, and regulating means can be left in the flushing system 10 while the flushing fluid conduit 96 is inserted, retained, or removed. The opening is also designed so that said directing, metering, and regulating means can be removed from the flushing system 10, have the flushing fluid conduit 96 inserted, retained, or removed, and then have the directing, metering, or regulating means with attached conduit 96 reinserted into the flushing system 10.

During normal operation, FIGS. 2 and 3, the outlet cap plug 82 is inserted into the opening 79 and screwed down until the outlet cap plug 82 seals against outlet cap plug sealing means 78. The outlet cap plug 82 can be screwed into or removed from the outlet cap 68 by pressing sideways on outlet cap plug tabs 94. This can be done when the outlet cap 68 is in the body 46 or after the outlet cap 68 has been removed from the body 46.

During normal operation, the multipurpose deflector 80 deflects some of the inlet cooling fluid up past the outlet cap plug sealing means 78 and into the outlet cap plug 82. The outlet cap plug 82 can be made from many materials, but in the preferred embodiment, it would be made from a clear material with a viewing means 84, thereby allowing a person aboard the vessel to easily see if fluid is flowing, and what might be suspended in the fluid; sand, silt, sea grass, etc.

As previously mentioned, when the flushing system 10 is in the standard running the engine position, FIGS. 3, 4A, and 4B, the position indicator 18 on the inlet cap 66 is lined up with the RUN indicator 26 on the body 46. When in this position, the internal fluid pressure keeps the inlet cap 66 in place. The inlet cap 66 has a recess 86 that serves to lock the cap into place during operation. The internal fluid pressure pushes upward on the inlet cap 66 engaging the recess 86 with the body 46. This ensures that the inlet cap 66 cannot vibrate loose during normal operation. The only way to remove the inlet cap 66 is to push down on the inlet cap 66, push sideways on the inlet cap tabs 88, and rotate the inlet cap 66 until the position indicator 18 on the inlet cap 66 is lined up with the FLUSH IN WATER REMOVE CAP indicator 28 on the body 46. When in this position, the inlet cap 66 can be pulled up and removed from the flushing system 10.

This same scenario is used for locking and removing the outlet cap 68. When the flushing system 10 is in the standard running the engine position, the position indicator 20 on the outlet cap 68 is lined up with the RUN indicator 30 on the body 46. When in this position, the internal fluid pressure keeps the outlet cap 68 in place. The outlet cap 68 has a recess 90 that serves to lock the cap into place during operation. The internal fluid pressure pushes upward on the outlet cap 68 engaging the recess 90 with the body 46. This ensures that the outlet cap 68 cannot vibrate loose during normal operation. The only way to remove the outlet cap 68 is to push down on the outlet cap 68, push sideways on the outlet cap tabs 92, and rotate the outlet cap 68 until the position indicator 20 on the outlet cap 68 is lined up with the REMOVE CAP indicator 23 on the body 46. When in this position, the outlet cap 68 can be pulled up and removed from the flushing system 10.

FIGS. 5 A and B show the same two views as seen in FIGS. 4 A and B, except this time the flushing system 10 is in the flushing the engine with the vessel out of the water position. Using the method previously described, the outlet cap 68 is removed from the flushing system 10. Then the outlet cap plug 82 is removed from the outlet cap 68 by pushing on the outlet cap plug tabs 94 and rotating the outlet cap plug 82 until it is completely unscrewed from the outlet cap 68. Then a conduit 96, generally a standard garden hose, is screwed into the outlet cap 68 until it seals against the outlet cap plug sealing means 78. The outlet cap 68, with attached conduit 96, is reinserted into the flushing system 10 and rotated until the position indicator 20 on outlet cap 68 is aligned with the FLUSH OUT OF WATER indicator 24 on the body 46. Next, the inlet cap 66 is rotated by pushing sideways on the inlet cap tabs 88 until the inlet cap position indicator 18 is lined up with the FLUSH OUT OF WATER indicator 24 on the body 46.

Once in this position the flushing fluid can be turned on and the engine 12 started. FIG. 5B shows the direction that the flushing fluid travels. The fluid enters the body 46 and the multipurpose deflector 80 and is directed back towards the inlet cap 66 and back down the inner conduit 62 until it reaches the seawater pump 34 or 43. The seawater pump 34 or 43 will resist the flow of fluid until the fluid reaches a particular backpressure. Once that backpressure is reached, fluid will begin to flow back through the seawater pump 34 or 43.

There are a number of ways that the multipurpose deflector 80 can create backpressure in the flushing system 10. Having a fixed orifice in the multipurpose deflector 80 can create backpressure, or having an opening in the multipurpose deflector 80 that the vessel's operator could increase or decrease would also create backpressure. In the preferred embodiment, the multipurpose deflector 80 has a pressure regulating means 98 that restricts the flow of fluid to the engine 12 and creates backpressure in the flushing system 10. Once enough pressure is created, the pressure regulating means allows fluid through to the engine 12. By creating backpressure in the flushing system 10, most of the flushing fluid travels through the pressure regulating means 98 and on to the engine 12; however, the backpressure forces enough fluid through the seawater pump 34 or 43 to keep it lubricated and cool while the engine 12 is running. The pressure regulating means 98 does not have to be completely sealed in order to function properly.

Once the flushing cycle is complete, the engine 12 and the flushing fluid are turned off, and the inlet cap 66 is rotated back to where the inlet cap position indicator 18 is lined up with the RUN indicator 26. Next, the outlet cap 68 is removed, and the flushing fluid conduit 96 is unscrewed. The outlet cap plug 82 is then screwed back into the outlet cap 68 until it seals on the outlet cap sealing means 78. Then the outlet cap position indicator 20 is lined up with the REMOVE CAP indicator 23, and the outlet cap 68 is inserted into the body 46 and rotated until the outlet cap position indicator 20 lines up with the RUN indicator 30 on the body 46. The flushing system 10 has now been returned to the standard engine running position.

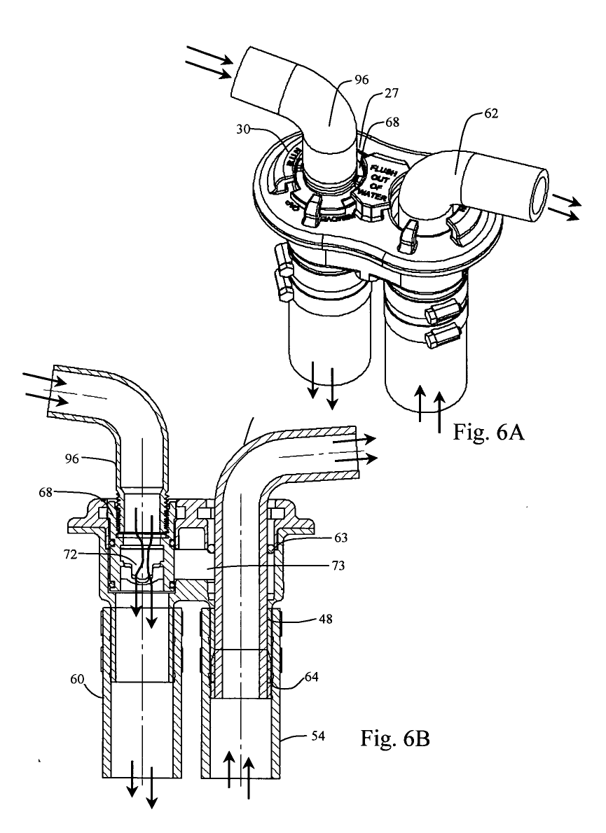

FIGS. 6A and B show the flushing system 10 in the flushing the engine with the vessel in the water position. To flush the engine with the vessel still in the water, first attach the flushing fluid conduit 96 to the outlet cap 68 as previously mentioned. Then the outlet cap 68, with attached conduit 96, is reinserted into the flushing system 10, and the position indicator 20 on outlet cap 68 is aligned with the FLUSH IN WATER indicator 27 on the body 46, FLUSH IN WATER indicator 27 can be seen more clearly in FIG. 2. Next, the inlet cap 66 is removed from the flushing system 46 by rotating the inlet cap 66 until the inlet cap position indicator 18 is lined up with the FLUSH-IN WATER REMOVE CAP indicator 28 on the body 46, FLUSH IN WATER REMOVE CAP indicator 28 can be seen more clearly in FIG. 2. Next the inlet cap 66 is pulled up and removed from the flushing system 10. This exposes the inner conduit 62. The inner conduit 62 is then pulled out of inlet extension conduit 54 until the inner conduit sealing means 64 seals against the inside of the inlet conduit 48 and the inner conduit sealing means 63 seals against the inner conduit 62 and the body 46. The free end of the inner conduit 62 is then pointed over the side of the vessel or into a drain aboard the vessel.

Next the flushing fluid is turned on and the engine 12 is started. At this time the engine 12 is being flushed with flushing fluid as described earlier; however, since the inner conduit sealing means 63 and 64 have sealed the entire inner conduit 62 from the common chamber 73, all of the flushing fluid travels to the engine 12. At the same time, fluid from the seawater pump 34 or 43 is allowed to travel its normal route until it gets to the flushing system 10. Instead of passing through the inner conduit 62 and on to the engine 12, it is just sent overboard so as not to unduly burden the seawater pump 34 or 43. The components between the flushing system 10 and the seawater pump 34 or 43 are not adversely affected by saltwater as long as the vessel remains in the water. It is only if the vessel is removed from the water and the residual saltwater dries that there is a problem.

Once the flushing cycle is complete, the engine 12 is turned off, the inner conduit 62 is pushed back down into the inlet extension conduit 54, the inlet cap position indicator 18 on the inlet cap 66 is lined up with the FLUSH IN WATER REMOVE CAP indicator 28 on the body 46, and the inlet cap 66 is pushed down into place. Then the inlet cap 66 is rotated so that the inlet cap position indicator 18 is lined up with the RUN position indicator 26. Next the outlet cap 68 is removed, as previously described, and the flushing fluid conduit 96 is unscrewed. The outlet cap plug 82 is then screwed back into the outlet cap 68 until it seals on the outlet cap sealing means 78. Then the outlet cap position indicator 20 is lined up with the REMOVE CAP indicator 23, and the outlet cap 68 is inserted into the body 46 and rotated until the outlet cap position indicator 20 lines up with the RUN indicator 30 on the body 46. The flushing system 10 has now been returned to the standard engine running position.

If the operator of the vessel does not return the inlet cap 66 or the outlet cap 68 to the correct position, the flushing system 10 will not operate as efficiently as it is designed to; however, neither the seawater pump 34 or 43 nor the engine 12 will be damaged. The inlet cap 66 can only be in one of three positions. During normal operation the position indicator 18 should be pointing towards the RUN position indicator 26. If it is pointing towards the FLUSH OUT OF WATER position indicator 24, the water from the seawater pump 34 or 43 will travel through the inlet cap 66 and out of the inlet cap opening 74 instead of inlet cap opening 70. If it is pointing towards the FLUSH IN WATER REMOVE CAP position indicator 28, the water from the seawater pump 34 or 43 will either flow out of both inlet cap openings 70 and 74 and around the cap and then on to the engine 12, or the water pressure will force the cap out of the flushing system 10 at which time a steady stream of water will be easily seen by the vessel's operator.

The outlet cap 68 can only be in one of four positions. During normal operation the position indicator 20 should be pointing towards the RUN position indicator 30. If it is pointing towards the FLUSH IN WATER position indicator 27, the water from the seawater pump 34 or 43 will flow around the outlet cap 68 and through outlet cap opening 72, and if the pressure gets high enough, it will also flow through outlet cap opening 71 and down through the pressure regulating means 98 and on to the engine 12. If it pointing towards the FLUSH OUT OF WATER position indicator 24 the water from the seawater pump 34 or 43 will immediately build high enough pressure to open the pressure regulating means 98 and flow on to the engine 12. If it is pointing towards the REMOVE CAP position indicator 23, the water will travel in the same manner as if it were pointing towards the FLUSH IN WATER position indicator 27, or the water pressure will force the cap out of the flushing system 10 at which time a steady stream of water will be easily seen by the vessel's operator.

In case of an emergency-flooding situation aboard a vessel whose engine 12 is still operational, the flushing system 10 can be converted into a high volume pump. The process is similar to the process one would use to flush the engine with the vessel in the water. As mentioned earlier, the insertion point for the flushing system 10 can be conduit 36, conduit 40, or conduit 44. Regardless of which of these insertion points is used, the first step is to remove the connecting means 56 from the bottom of the outlet extension conduit 60. This exposes the end of the outgoing fluid conduit 58, (which is now the engine inlet conduit), to the flooding water. Since the engine 12 is running, it will pull in excess flooding water through the engine inlet conduit 58 and pump it through the engine 12 and out of the vessel. During this time, the seawater pump 34 or 43 will still be pumping water into the same area that the engine 12 is pulling water from. Therefore, to complete the emergency pumping process, the inlet cap 66 is removed as described earlier, and the inner conduit 62 is pulled out just like in the flushing in water process. Now all of the fluid that is being pulled into the vessel from the seawater pump 34 or 43 is sent through the inner conduit 62 and either overboard or into a drain, and the engine 12 is using the excess flooding water as coolant and pumping it out of the vessel.

Once the emergency situation has been remedied, the inner conduit 62 and the inlet cap 66 are returned to their original running the engine positions, as previously described, and the outlet extension conduit 60 is reattached to the outgoing fluid conduit 58 using the same connecting means 56.

Although a preferred embodiment of the invention has been described using specific terms, such description is for illustrative purposes only, and it is to be understood that changes and variations may be made without departing from the spirit or scope of the following claims.

1. A flushing system for a marine propulsion system comprising:
an attachment means that allows for cooling fluid to flow into said system;
an attachment means that allows for cooling fluid to flow out of said system;
a first extension means that connects the upstream cooling fluid to the flushing system inlet thereby allowing the flushing system to be located some distance from said propulsion system;
a second extension means that connects the flushing system outlet to the downstream cooling fluid thereby allowing the flushing system to be located some distance from said propulsion system; and
a means for regulating flow and/or pressure of cooling fluids into and out of said system.

2. The flushing system as set forth in claim 1 and further having a body that has a plurality of chambers so as to allow for various fluids to enter the system and be directed into a plurality of directions, the body comprising:
an inlet that is attached to the said upstream cooling fluid extension means;
an outlet that is attached to the said downstream cooling fluid extension means;
a common chamber disposed between the inlet and outlet, said common chamber having a plurality of sections that allow for fluid directing, metering, or regulating means to be inserted, repositioned, retained, or removed to direct, meter, or regulate the flow or pressure of fluids into and out of the flushing system;
a feature that allows for the directional installation of said flushing system relative to the vessel's cooling fluid flow path; and
a feature that allows for the attachment of measuring means used for measuring attributes of the fluid passing through the flushing system.

3. The flushing system as set forth in claim 1 and further having an extending portion that can direct fluid to the rest of said common chamber or direct fluid out of said common chamber; and
an extending portion that contains sealing means that ensures that fluids flow through and not around said extending portion.

4. The body as set forth in claim 2 and further having a plurality of holding features that allow for the fluid directing, metering, or regulating means to be inserted, repositioned, retained or removed; and
a plurality of indicating symbols and/or alphanumerics that aid in the inserting, repositioning, retaining, or removing of said fluid directing, metering, or regulating means.

5. The flushing system as set forth in claim 1 and further having directing, metering, or regulating means that can be inserted, repositioned, retained or removed from said body comprising:
a plurality of sealing means that ensure that fluids passing through or around the directing, metering, or regulating means do so without leaking into portions of the flushing system not intended for fluids or without leaking out of the flushing system;
a feature that allows said body to retain said directing, metering, or regulating means in a manner that prevents the directing, metering, or regulating means from accidentally coming out of the body or changing position;
a plurality of openings that allow for multi-directional full fluid flow through the directing, metering, or regulating means, multi-directional metered fluid flow through the directing, metering, or regulating means, and/or multi-directional regulated fluid flow through the directing, metering, or regulating means;
a turning means used to facilitate the inserting, repositioning, and/or removing of said directing, metering, or regulating means; and
a feature that allows for the direct measuring of attributes of the fluids passing through the directing, metering, or regulating means.

6. The directing, metering, or regulating means as set forth in claim 5 and further having a retaining means that allows the directing, metering, or regulating means to remain tethered to the flushing system without interfering with system functions so as to prevent accidental loss of said directing, metering, or regulating means.

7. The flushing system as set forth in claim 1 and further having directing, metering, or regulating means that can be inserted, repositioned, retained or removed from said body comprising:
a plurality of sealing means that ensure that fluids passing through or around the directing, metering, or regulating means do so without leaking into portions of the flushing system not intended for fluids or without leaking out of the flushing system;
a feature that allows said body to retain said directing, metering, or regulating means in a manner that prevents the directing, metering, or regulating means from accidentally coming out of the body or changing position;
a plurality of openings that allow for multi-directional full fluid flow through the directing, metering, or regulating means, multi-directional metered fluid flow through the directing, metering, or regulating means, or multi-directional regulated fluid flow through the directing, metering, or regulating means; and
a turning means used to facilitate the insertion, rotation, and removal of said directing, metering, or regulating means.

8. The directing, metering, or regulating means as set forth in claim 7 and further having a fluid redirecting means comprising:
a redirecting means that causes a portion of the fluid flow to be diverted along a path different from the main fluid flow path; and
a fluid redirecting means that causes the diverted fluid to rejoin the main fluid flow path.

9. The directing, metering, or regulating means as set forth in claim 7 and further having a fluid modifying means comprising:
a modifying means that may direct, meter, or regulate fluid passing through the flushing system equally in any direction; and
a modifying means that may direct, meter, or regulate fluid passing through the flushing system more in one direction than in another.

10. The directing, metering, or regulating means as set forth in claim 7 and further having a fluid modifying means comprising:
a fluid modifying means that can be adjusted to modify the fluids passing through the flushing system during the flushing cycle and readjusted for normal operation; or
a fluid modifying means that continuously modifies the fluids passing through the flushing system.

11. The adjustable fluid modifying means as set forth in claim 10 and further having a safety function, said safety function allows the adjustable fluid modifying means to be left in the wrong position after flushing the vessel and not adversely affect the vessel's propulsion system.

12. The directing, metering, or regulating means as set forth in claim 7 and further having an opening that allows for the insertion, retention, and removal of a flushing fluid conduit that is used to bring flushing fluid into the flushing system.

13. The directing, metering, or regulating means as set forth in claim 7 and further having an opening designed so that said directing, metering, or regulating means can be left in the flushing system while the flushing fluid conduit is inserted, retained, or removed from the flushing system; and
an opening designed so that said directing, metering, or regulating means can be removed from the flushing system prior to having the flushing fluid conduit inserted, retained, or removed, and then having the directing, metering, or regulating means with attached flushing fluid conduit reinserted into the flushing system.

14. The directing, metering, or regulating means as set forth in claim 7 and further having a retaining means that allows the directing, metering, or regulating means to remain tethered to the flushing system body without interfering with system functions so as to prevent accidental loss of said directing, metering, or regulating means.

15. The directing, metering, or regulating means as set forth in claim 7 and further having an opening that allows for the insertion, retention, and removal of a flushing fluid conduit sealing means comprising:
a turning means used to facilitate the insertion, retention, and removal of said flushing fluid conduit sealing means; and
a sealing means that ensures that fluid passing into or by said flushing fluid conduit sealing means does so without leaking into portions of the flushing system not intended for fluid or without leaking out of the flushing system.

16. The flushing fluid conduit sealing means as set forth in claim 15 and further having a material that allows said flushing fluid conduit sealing means to be transparent or translucent so as to facilitate viewing the fluids passing through the flushing system.

17. The flushing fluid conduit sealing means as set forth in claim 15 and further having a retaining means that allows the flushing fluid conduit sealing means to remain tethered to the flushing system body or the directing, metering, or regulating means without interfering with system functions so as to prevent accidental loss of said flushing fluid conduit sealing means.

18. The flushing system as set forth in claim 1 that can be used as an emergency high volume fluid pump comprising:
a fluid directing means that can direct fluid normally destined for cooling the engine overboard or into a drain; and
a fluid directing means normally connected to the flushing system that can be used as the inlet for the engine's cooling system, said fluid directing means would be placed into the water that needed to be removed from the vessel.

19. The directing, metering, or regulating means as set forth in claim 7 and further having the ability to be used without the directing, metering, or regulating means as set forth in claim 5 for specific flushing circumstances.
